(19) United States
(12) Patent Application Publication
(10) Pub. No.: US 2012/0013650 A1
(43) Pub. Date: Jan. 19, 2012

(54) DISPLAY DEVICE

(75) Inventor: Naoki Mizubuchi, Osaka (JP)

(73) Assignee: SHARP KABUSHIKI KAISHA, Osaka-shi, Osaka (JP)

(21) Appl. No.: 13/138,751

(22) PCT Filed: Jun. 11, 2010
(86) PCT No.: PCT/JP2010/059964

§ 371 Date: Sep. 23, 2011

(30) Foreign Application Priority Data
Jun. 19, 2009 (JP) 2009-146355

(51) Int. Cl. G09G 5/10

(52) U.S. Cl. 345/690

(57) ABSTRACT

A display device with a simple structure is provided where the number of electrical lines connected to the active matrix substrate can be reduced even when the number of pixels in the display module is increased. A liquid crystal display device includes a superimposing circuit (superimposing module) that superimposes a lighting signal for a light-emitting diode (light source) on a drive signal for a data line drive circuit (drive circuit) and a scan line drive circuit (drive circuit) to generate a superimposed signal. On the active matrix substrate are provided a photosensor unit (light-electricity transducer) that receives light from the light-emitting diode and outputs an electrical signal corresponding to the received light, and a decoding circuit (decoding module) that decodes the electrical signal from the photosensor unit to the drive signal for the data line drive circuit and the scan line drive circuit.

### TECHNICAL FIELD

The present invention relates to display devices, more particularly to non-emissive displays such as liquid crystal display devices.

### BACKGROUND ART

Liquid crystal display devices, for example, are widely used in liquid crystal television sets, monitors, cell phones or the like, in the form of flat panel displays, which are thinner and lighter than conventional cathode-ray tubes. Such a liquid crystal display device includes a backlight that emits light and a liquid crystal panel that serves as a shutter for light from the backlight to display a desired image.

Further, in such a liquid crystal display device, an arrangement in which a plurality of data lines (source lines) and a plurality of scan lines (gate lines) are laid out in a matrix is known. In such a liquid crystal display device, an active matrix substrate is used for a liquid crystal panel as a display module displaying information, where the active matrix substrate includes pixels each having a switching device such as a thin film transistor (TFT) near the intersection between a data line and a scan line, the pixels being laid out in a matrix.

Furthermore, a conventional liquid crystal display device generally includes a data line drive circuit (source driver) that outputs data signals to data lines and a scan line drive circuit (gate driver) that outputs scan signals to scan lines in order to drive the liquid crystal layer on a pixel-by-pixel basis. Also, in a conventional liquid crystal display device, the data line drive circuit and the scan line drive circuit are formed on the active matrix substrate using COG (chip-on-glass) mounting, for example. Further, in a conventional liquid crystal display device, a display control device that generates and outputs instruction signals for the data line drive circuit and the scan line drive circuit in response to video signals from the outside is connected to the data line drive circuit and the scan line drive circuit via a flexible printed circuit (FPC) (see, for example, JP2005-309018A).

Furthermore, in a conventional liquid crystal display device, as disclosed in JP2007-171321A, for example, providing a solar cell at each pixel is proposed on the active matrix substrate of the liquid crystal panel. In such a conventional liquid crystal display device, the solar cells are used to generate electrical power from incoming light such as environment light (external light) or backlight. In such a conventional liquid crystal display device, the generated electrical power may be used to drive the data line drive circuit and the scan line drive circuit on the active matrix substrate. Thus, electrical power supplied from outside the liquid crystal panel can be reduced.

### DISCLOSURE OF THE INVENTION

In such liquid crystal display devices, liquid crystal panels (display modules) with larger screen size and higher definition require increased numbers of pixels.

However, in such a conventional liquid crystal display device, an increased number of pixels of a liquid crystal panel leads to an increased number of electrical lines connected to the active matrix substrate. This causes problems such as an increased number of flexible printed circuits, larger size of circuitry or the like.

An object of the present invention is to provide a display device with a simple structure where the number of electrical lines connected to the active matrix substrate can be reduced even when the number of pixels in the display module is increased.

A display device according to an embodiment of the present invention is a display device including a backlight module having a light source and a display module having an active matrix substrate with a plurality of pixels for displaying information using illumination light generated by the backlight module, the display device including a backlight control module that outputs a lighting signal for drive-controlling the backlight module and a display control module that outputs a drive signal for drive-controlling the display module, wherein on the active matrix substrate are provided: a drive circuit that drives the plurality of pixels on a pixel-by-pixel basis; a superimposing module that superimposes the drive signal output from the display control module on the lighting signal output from the backlight control module to generate a superimposed signal and output the superimposed signal to the backlight module; a light-electricity transducer that receives light from the light source and outputs an electrical signal corresponding to the received light; and a decoding module that decodes the electrical signal from the light-electricity transducer to the drive signal and outputs it to the drive circuit.

According to the present embodiment, it is possible to provide a display device with a simple structure where the number of electrical lines connected to the active matrix substrate can be reduced even when the number of pixels in the display module is increased.

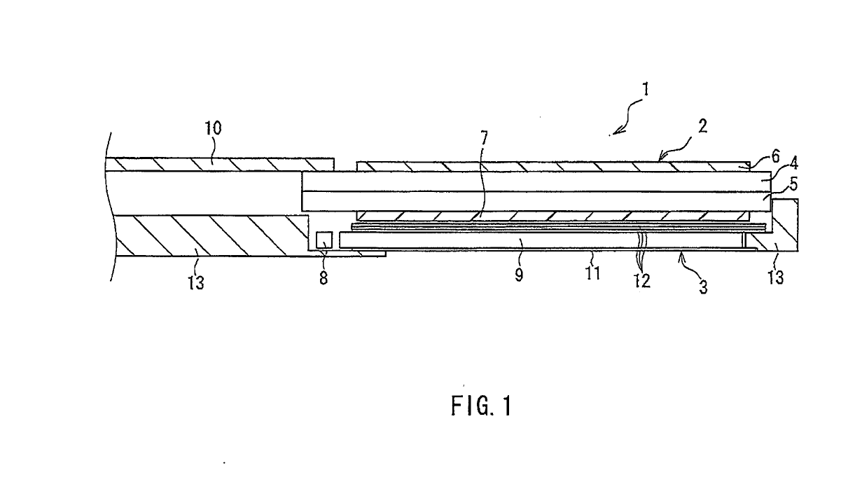

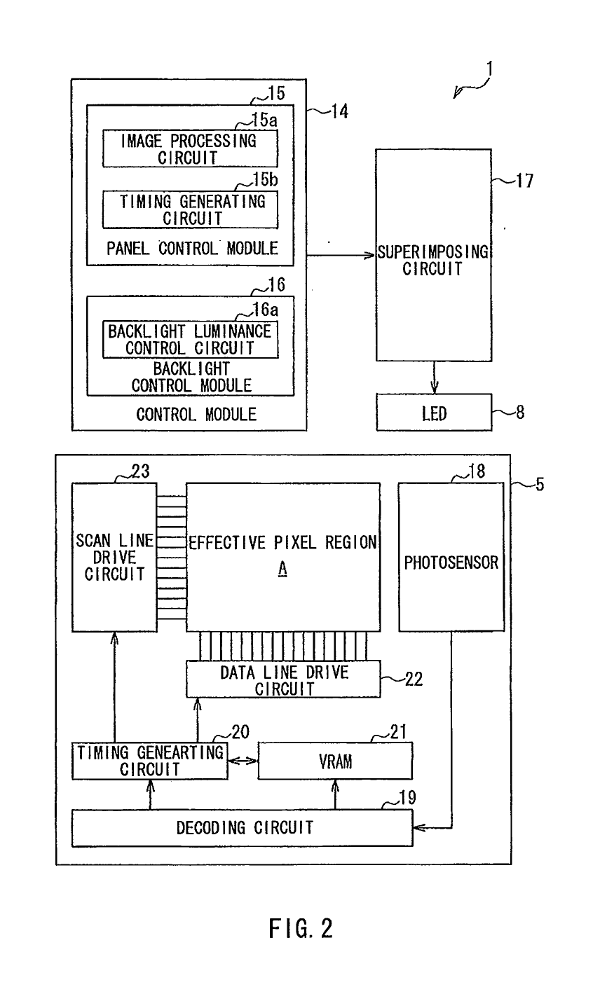

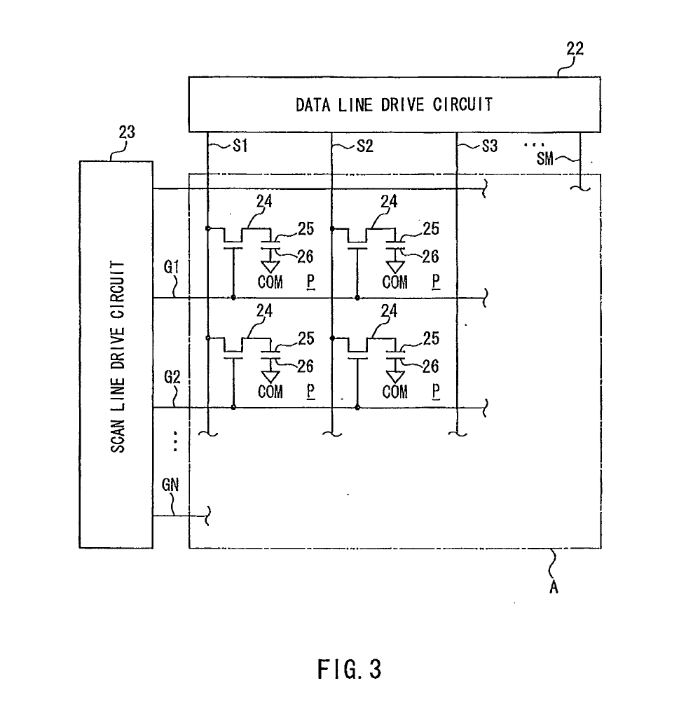

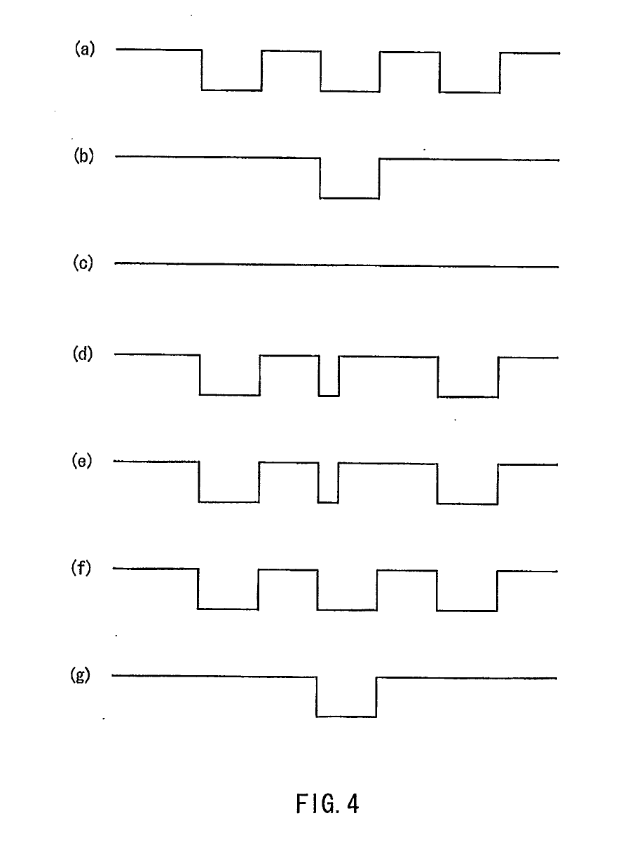

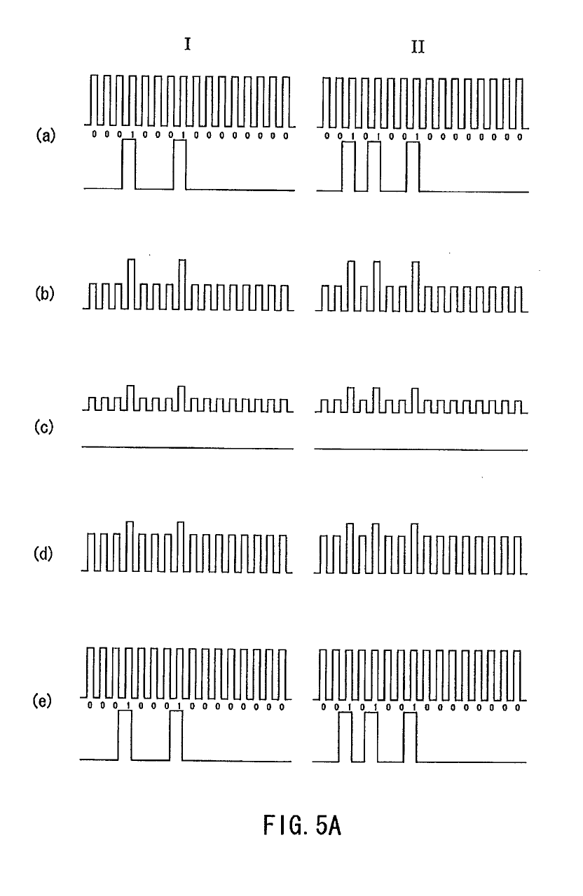

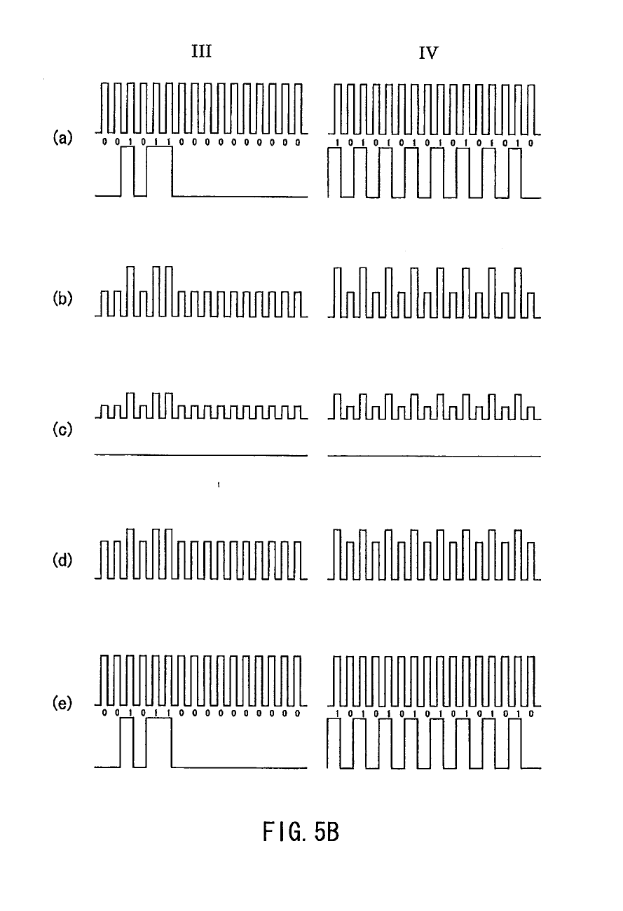

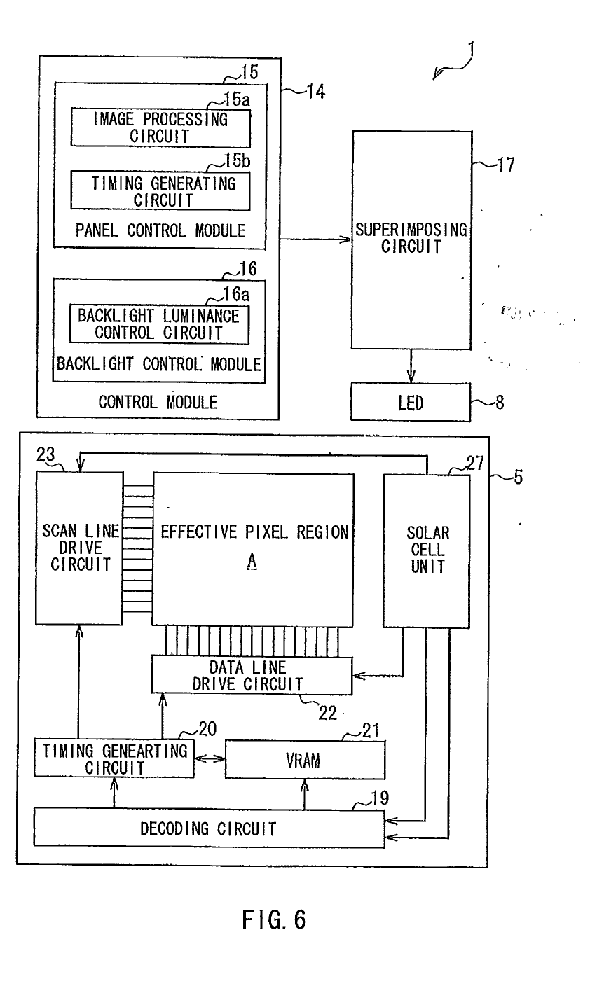

### BRIEF DESCRIPTION OF THE DRAWINGS

[FIG. 1] FIG. 1 illustrates the structure of a liquid crystal display device according to a first embodiment of the present invention.

[FIG. 2] FIG. 2 illustrates the configuration of main portions of the liquid crystal display device.

[FIG. 3] FIG. 3 illustrates the configuration of pixels on the active matrix substrate shown in FIG. 2.

[FIG. 4] FIGS. 4 (a) to (g) show examples of signal waveforms in various portions of the liquid crystal display device.

[FIG. 5A] FIG. 5A shows examples of signal waveforms in various portions of the liquid crystal display device when image data is transmitted to the active matrix substrate.

[FIG. 5B] FIG. 5B shows examples of signal waveforms occurring in various portions of the liquid crystal display device when image data is transmitted to the active matrix substrate.

[FIG. 6] FIG. 6 illustrates the configuration of main portions of a liquid crystal display device according to a second embodiment of the present invention.

### EMBODIMENTS FOR CARRYING OUT THE INVENTION

A display device according to an embodiment of the present invention is a display device including a backlight module having a light source and a display module having an active matrix substrate with a plurality of pixels for displaying information using illumination light generated by the backlight module, the display device including a backlight control module that outputs a lighting signal for drive-controlling the backlight module and a display control module that outputs a drive signal for drive-controlling the display module, wherein on the active matrix substrate are provided: a drive circuit that drives the plurality of pixels on a pixel-by-pixel basis; a superimposing module that superimposes the drive signal output from the display control module on the lighting signal output from the backlight control module to generate a superimposed signal and output the superimposed signal to the backlight module; a light-electricity transducer that receives light from the light source and outputs an electrical signal corresponding to the received light; and a decoding module that decodes the electrical signal from the light-electricity transducer to the drive signal and outputs it to the drive circuit (first arrangement).

In such a display device, a superimposing module is provided to superimpose a lighting signal for the light source on a drive signal for the drive circuit to generate a superimposed signal and output the superimposed signal to the backlight module. Further, on the active matrix substrate are provided a light-electricity transducer that receives light from the light source and outputs an electrical signal corresponding to the received light, and a decoding module that decodes the electrical signal from the light-electricity transducer to the drive signal for the drive circuit and outputs it to the drive circuit. Thus, a signal can be input from the display control module to the active matrix substrate using light, thereby eliminating the necessity of electrical lines between the display control module and the active matrix substrate. Accordingly, contrary to a conventional implementation as discussed above, this arrangement will achieve a display device with a simple structure where the number of electrical lines connected to the active matrix substrate can be reduced even when the number of pixels in the display module is increased.

In the first arrangement, it is preferable that the light-electricity transducer is a photosensor unit (second arrangement). In this case, the photosensor unit receives light from the light source and outputs a detection signal corresponding to the received light in the form of an electrical signal to the decoding module.

In the first arrangement, it is preferable that the light-electricity transducer is a solar cell unit, and the solar cell unit is configured to obtain electrical power from the received light, in addition to the electrical signal, and supply the electrical power to the drive circuit and the decoding module (third arrangement).

In this case, the solar cell unit provides electrical power required for the solar cell unit itself, drive circuit and decoding module. As a result, power consumption of the display device can be easily reduced. In addition, electrical lines for supplying electrical power to the active matrix substrate can be omitted, such that a display device with a simple structure can be designed in an easy way.

In any one of the first to third arrangements, it is preferable that the drive signal contains a clock signal and a data signal corresponding to a video signal from an outside (fourth arrangement). In this case, the light source can be turned on in timing suitable for the video signal and a plurality of pixels can be driven suitably for the video signal.

In any one of the first to fourth arrangements, it is preferable that the display module includes a liquid crystal panel, and on the active matrix substrate are provided a plurality of data lines and a plurality of scan lines arranged in a matrix and switching devices near intersections between the data lines and the scan lines, and the drive circuit contains a data line drive circuit connected to the data lines and a scan line drive circuit connected to the scan lines (fifth arrangement).

In this case, a liquid crystal display device with a simple structure can be obtained where the number of electrical lines connected to the active matrix substrate can be reduced even when the number of pixels on the liquid crystal panel is increased.

### Embodiments

Preferred embodiments of display devices will now be described with reference to the drawings. In the description below, transmissive liquid crystal display devices are set forth as examples. It should be noted that the sizes of the components in the drawings do not exactly represent the sizes of the actual components nor the size ratios of the components.

### First Embodiment

FIG. 1 illustrates a liquid crystal display device according to a first embodiment of the present invention. In FIG. 1, a liquid crystal display device 1 of the present embodiment includes a liquid crystal panel 2 as a display module, where the upper side in FIG. 1 is the viewer's side (display side), and a backlight device 3 as a backlight module that is located on the non-display side (lower side in FIG. 1) of the liquid crystal panel 2 and generates illumination light that illuminates the liquid crystal panel 2.

The liquid crystal panel 2 includes a pair of substrates, i.e. a CF (color filter) substrate 4 and an active matrix substrate 5, and polarizers 6 and 7 that sandwich the CF substrate 4 and the active matrix substrate 5. A liquid crystal layer, not shown, is sandwiched between the CF substrate 4 and the active matrix substrate 5. The CF substrate 4 and the active matrix substrate 5 each may be a plate of a transparent glass material or a transparent synthetic resin such as an acrylic resin. The polarizers 6 and 7 each may be a resin film such as TAC (triacetylcellulose) or PVA (polyvinyl alcohol). Each of the polarizers 6 and 7 is attached to the corresponding one of the CF substrate 4 and the active matrix substrate 5 to cover at least the effective pixel region of the display side provided in the liquid crystal panel 2.

The active matrix substrate 5 constitutes one of the pair of substrates. Pixel electrodes, thin film transistors (TFTs), discussed below, and other components are formed between the active matrix substrate 5 and the liquid crystal layer to correspond to the pixels contained in the display side of the liquid crystal panel 2. Further, a photosensor unit, a decoding circuit and other components are mounted on the active matrix substrate 5, as discussed in detail below. Thus, pixels are driven by illumination light from the backlight device 3 such that the liquid crystal panel 2 displays information such as characters and images. The CF substrate 4 constitutes the other one of the pair of substrates. A color filter, an opposite electrode, discussed below, and other components are formed between the CF substrate 4 and the liquid crystal layer.

It should be noted that any liquid crystal mode or any pixel structure may be used for the liquid crystal panel 2. Further, any drive mode may be used for the liquid crystal panel 2. More particularly, any liquid crystal panel capable of displaying information may be used as the liquid crystal panel 2. Accordingly, no detailed structure of the liquid crystal panel 2 is shown in FIG. 1 and no description thereof is provided herein.

The backlight device 3 includes a light-emitting diode (LED) 8 as a light source and a light guide plate 9 opposite the light-emitting diode 8. Further, in the backlight device 3, the light-emitting diode 8 and the light guide plate 9 are supported by a bezel 13, where the liquid crystal panel 2 is placed on the viewer's side of the light guide plate 9. Furthermore, a case 10 is mounted on the CF substrate 4. Thus, the backlight device 3 cramps the liquid crystal panel 2 and is integrated into the liquid crystal panel 2 as a transmissive liquid crystal display device 1 where illumination light from the backlight device 3 enters the liquid crystal panel 2.

The light guide plate 9 is made of a synthetic resin such as a transparent acrylic resin, for example, and light from the light-emitting diode 8 enters the light guide plate. A reflecting sheet 11 is placed on the side of the light guide plate 9 opposite the liquid crystal panel 2 (the opposite side). Further, optical sheets 12 such as a lens sheet and a diffusion sheet are provided on the side of the light guide plate 9 facing the liquid crystal panel 2 (the light emitting side). Light from the light-emitting diode 8 guided in a predetermined light guide direction (from the left to the right in FIG. 1) through the light guide plate 9 is transformed into planar illumination light, mentioned above, having a homogeneous luminance and is supplied to the liquid crystal panel 2.

It should be noted that, while an arrangement using an edge-light backlight device 3 including a light guide 9 has been described in the above description, the present embodiment is not limited thereto, and a direct-lighting backlight device may also be used.

Now, a specific configuration of the liquid crystal display device 1 of the present embodiment will be described with reference to FIGS. 2 and 3.

FIG. 2 illustrates the configuration of main portions of the liquid crystal display device 1. FIG. 3 illustrates the configuration of pixels on the active matrix substrate shown in FIG. 2.

As shown in FIG. 2, the liquid crystal display device 1 of the present embodiment includes a control module 14 that performs drive control of the liquid crystal panel 2 (FIG. 1) and the backlight device 3 (FIG. 1), and a superimposing circuit 17 as a superimposing module connected between the control module 14 and the light-emitting diode (LED) 8. The liquid crystal display device 1 is configured in such a way that the light-emitting diode 8 is turned on based on a superimposed signal from the superimposing circuit 17. The superimposed signal also contains a data signal of information to be displayed on the display side of the liquid crystal panel 2, as discussed below. The light-emitting diode 8 is configured in such a way that the amount of emitted light varies minimally in accordance with the data signal contained in the superimposed signal. The control module 14 is supplied with a video signal from an external device (not shown) such as a tuner or a recorder/player. The control module 14 is also supplied with a dimming instruction signal that indicates an luminance (brightness) at the display side by a controller (not shown) provided in the liquid crystal display device 1.

The control module 14 also incorporates a panel control module 15 as a display control module including an image processing circuit 15a and a timing generating circuit 15b, and a backlight control module 16. The image processing circuit 15a performs predetermined image processing upon an input video signal to generate a data signal. Then, the image processing circuit 15a outputs the generated data signal to the timing generating circuit 15b. The timing generating circuit 15b outputs the data signal from the image processing circuit 15a and a clock signal, where output transitions between a high level and a low level in a predetermined cycle, to the superimposing circuit 17. The data signal and the clock signal constitute drive signals for the data line drive circuit and the scan line drive circuit, as discussed below.

The backlight control module 16 includes a backlight luminance control circuit 16a. The backlight control module 16 is configured to turn on the light-emitting diode 8 using current dimming, for example. The backlight luminance control circuit 16a generates a lighting signal for the light-emitting diode 8 based on the input dimming instruction signal and outputs it to the superimposing circuit 17.

The superimposing circuit 17 superimposes the data signal and clock signal (drive signals) input from the panel control module 15 on the lighting signal from the backlight control module 16 to generate a superimposed signal and outputs it to the light-emitting diode 8 in the backlight device 3.

Further, as shown in FIG. 2, on the active matrix substrate 5 are provided: a photosensor unit 18 as a light-electricity transducer; a decoding circuit 19 as a decoding module connected to the photosensor unit 18; a timing generating circuit 20 and a VRAM (video random access memory) 21 connected to the decoding circuit 19. On the active matrix substrate 5 are also provided a data line drive circuit 22 and a scan line drive circuit 23 as drive circuits connected to the timing generating circuit 20 for driving pixels on a pixel-by-pixel basis. The photosensor unit 18, the decoding circuit 19, the timing generating circuit 20, the VRAM 21, the data line drive circuit 22 and the scan line drive circuit 23 are provided outside the effective pixel region A of the display side and on the active matrix substrate 5, as shown in FIG. 2.

Further, as shown in FIG. 3, on the active matrix substrate 5, a plurality of data lines (source lines) S1 to SM (M is an integer not smaller than 2; hereinafter collectively referred to as “S”) are connected to the data line drive circuit (source driver) 22 and a plurality of scan lines (gate lines) G1 to GN (N is an integer not smaller than 2; hereinafter collectively referred to as “N”) are connected to the scan line drive circuit (gate driver) 23. The data line drive circuit 22 is configured to output, to a data line S, a voltage signal corresponding to a video signal from the outside in response to an instruction signal from the timing generating circuit 20. The scan line drive circuit 23 is configured to sequentially output a scan signal to a scan line G in response to an instruction signal from the timing generating circuit 20.

The data lines S and the scan lines G are arranged in a matrix at least in the effective pixel region A. Each of the areas in this matrix contains one of the pixels P. The pixels P include red, green and blue pixels. The red, green and blue pixels may be sequentially arranged in this order, for example, parallel to the scan lines G.

Each pixel P has a thin film transistor 24 as a switching device. The thin film transistor 24 has a gate connected to a scan line G and a source connected to a data line S. The thin film transistor 24 has a drain connected to a pixel electrode 25, which is provided for each pixel P. In each pixel P, a common electrode 26 is provided opposite the pixel electrode 25, with the liquid crystal layer being sandwiched in between.

Returning to FIG. 2, the photosensor unit 18 is provided on the active matrix substrate 5 in such a way that its light receiving side is opposite the light guide plate 9 (FIG. 1). In other words, the photosensor unit 18 is configured to detect only light from the light-emitting diode 8, and not to receive light from outside the liquid crystal display device 1 (external light). After receiving light from the light-emitting diode 8, the photosensor unit 18 is configured to output, to the decoding circuit 19, a detection signal corresponding to the received light in the form of an electrical signal.

The decoding circuit 19 decodes the electrical signal output from the photosensor unit 18 into a data signal and a clock signal which are the drive signals mentioned above. Then, the decoding circuit 19 outputs the data signal and the clock signal from the decoding to the timing generating circuit 20 and the VRAM 21.

The VRAM 21 is configured to obtain video data from out of the data signal output from the decoding circuit 19 and hold the video data on a frame basis.

The timing generating circuit 20 uses the data signal and the clock signal output from the decoding circuit 19 to read out one frame of video data held in the VRAM 21. The timing generating circuit 20 then generates an instruction signal corresponding to the read-out video data and outputs the instruction signal to the data line drive circuit 22. The data line drive circuit 22 generates a voltage signal, mentioned above, and outputs the voltage signal to a data line S. Further, the timing generating circuit 20 uses the clock signal output from the decoding circuit 19 to generate an instruction signal for the scan line drive circuit 23 and outputs the instruction signal to the scan line drive circuit 23. The scan line drive circuit 23 generates a scan signal, mentioned above, and outputs the scan signal to a scan line G.

Now, also referring to FIG. 4, operations of the liquid crystal display device 1 of the present embodiment configured as above will be described. In the following description, the superimposing processes at the superimposing circuit 17 and the decoding processes at the decoding circuit 19 are mainly described.

FIGS. 4 (a) to (g) illustrate examples of signal waveforms in various portions of the liquid crystal display device.

When supplied with a data signal as illustrated in FIG. 4(b) from the image processing circuit 15a, the timing generating circuit 15b outputs a clock signal shown in FIG. 4(a) and the data signal to the superimposing circuit 17. The data signal is a binary signal corresponding to a video signal from the outside, as illustrated in FIG. 4(b), where one of the high level set and the low level set indicates the data “0” and the other set indicates the data “1”. In the clock signal, the period of each of the high and low levels corresponds to a period that indicates one bit of data in the data signal. Further, the drive signals including the clock signal and data signal may be serial signals complying with the I²C or MIPI DPI standards, for example.

The backlight luminance control circuit 16a generates a lighting signal for the light-emitting diode 8 based on a dimming instruction signal from the outside, as illustrated in FIG. 4(c), and outputs the lighting signal to the superimposing circuit 17. The superimposing circuit 17 then superimposes the clock signal, the data signal and the lighting signal, shown in FIG. 4(a), (b) and (c), respectively, upon one another to generate a superimposed signal (illustrated in FIG. 4(d)). The superimposing circuit 17 outputs the generated superimposed signal to the backlight device 3. The light-emitting diode 8 is turned on in accordance with the superimposed signal. It should be noted that the superimposed signal shown in FIG. 4(d) indicates that the currents supplied to the light-emitting diode 8 for the high levels and the low levels are, for example, 20 mA and 19.5 mA, respectively. In other words, the level of current supplied to the light-emitting diode 8 is adjusted to values with minimal variations such that the variations in the luminance of the liquid crystal display device 1 are substantially imperceptible. Thus, at the light-emitting diode 8, the supplied current level varies minimally in accordance with clock signals and data signals, such that the amount of light from the light-emitting diode 8 (brightness) also varies minimally in accordance with the clock signals and data signals.

When the light-emitting diode 8 is turned on as described above, the photosensor unit 18 obtains a detection signal in which the minimal variations in luminance are detected, as illustrated in FIG. 4(e). The photosensor unit 18 then outputs the detection signal in the form of an electrical signal to the decoding circuit 19.

Thereafter, the decoding circuit 19 decodes the electrical signal output from the photosensor unit 18 and obtains a clock signal and a data signal illustrated in FIGS. 4(f) and (g), respectively. These clock and data signals are the same as the clock and data signals shown in FIGS. 4(a) and (b), respectively, i.e. the same as the signals output from the timing generating circuit 15b to the superimposing circuit 17.

Now, examples of signal waveforms that are used when image data to be displayed on the liquid crystal panel 2 is transferred to the active matrix substrate 5 by means of turning-on of the light-emitting diode 8, as described above, are shown in FIGS. 5A and 5B. FIGS. 5A and 5B show examples of signal waveforms occurring in various portions when various signals I to IV are transferred within the liquid crystal display device 1 (the signals I to IV correspond to I to IV in the drawings). It should be noted that the various signals I to IV shown in FIGS. 5A and 5B show examples of various signals that are used when the liquid crystal display device 1 is started up and the image data is transmitted.

First, after the main power of the liquid crystal display device 1 is turned on, the signal I for starting up the liquid crystal display device 1 from sleep mode is output from the control module 14 to the superimposing circuit 17. The signal I may be, for example, a signal represented hexadecimally as “1100”, and may have a signal waveform as shown in the lower half of I(a) in FIG. 5A. The superimposing circuit 17 superimposes the signal I upon the clock signal shown in the upper half of I(a) in FIG. 5A. The superimposed signal exhibits a high level whenever the signal I is at the high level, resulting in a signal waveform shown in I(b) in FIG. 5A. The superimposing circuit 17 also superimposes a lighting signal for the light-emitting diode 8 upon the signal I/clock signal to generate a superimposed signal, as shown in I(c) in FIG. 5A. The superimposed signal is output to the light⁻emitting diode 8, such that the light-emitting diode 8 is turned on in accordance with the superimposed signal.

Light from the light-emitting diode 8 is received by the photosensor unit 18 on the active matrix substrate 5, and converted to a signal, as in I(d) in FIG. 5A. The decoding circuit 19 then divides the signal into the clock signal and the signal I, as shown in I(e) in FIG. 5A.

In this way, a signal I and a clock signal can be transferred to the active matrix substrate 5 using light.

In the liquid crystal display device 1, after a signal I is transferred to the active matrix substrate 5 and then the liquid crystal display device 1 is started up from sleep mode, a signal II for starting up the display (for example, a signal represented hexadecimally as “2900”; see II in FIG. 5A) is transferred by the light-emitting diode 8 to the active matrix substrate 5 using light, similar to the signal I above. Thereafter, a signal III indicating the initiation of transfer of image data (for example, a signal represented hexadecimally as “2C00”; see III in FIG. 5B) is output to the active matrix substrate 5 using light, similar to the signal I above.

The image data transferred to the active matrix substrate 5 is stored in the VRAM 21 and then read out from the VRAM 21 by the timing generating circuit 20 as video data on a frame basis. The VRAM 21 is configured to store one frame of data divided into a plurality of blocks of R, G and B. In the case of QVGA (quarter video graphic array), for example, one frame of data is divided into 240×320 blocks. Each block has data for the colors R, G and B. Thus, the pieces of data corresponding to the blocks of one frame of an image are sequentially output to the active matrix substrate 5 as a data signal IV (for example, a signal represented hexadecimally as “AAAA”; see IV of FIG. 5B). Similar to the signal I above, the signal IV is superimposed by the superimposing circuit 17 on the clock signal and a lighting signal, and then transferred by the light-emitting diode 8 and the photosensor unit 18 to the active matrix substrate 5.

FIGS. 5A and 5B show how various signals are transferred as 16-bit data. In the present embodiment, data for each color in a block is 8 bits long, such that data for two colors is transmitted at once as a signal IV to the active matrix substrate 5. It should be noted that the above embodiment is not limitative and the various signals may be transmitted as data other than 16-bit, or other types of signals may be transmitted. Further, the various signals shown in FIGS. 5A and 5B may be in any signal waveform.

The liquid crystal display device 1 of the present embodiment configured in this way includes a superimposing circuit (superimposing module) 17 that superimposes a lighting signal for the light-emitting diode (light source) 8 on a drive signal for the data line drive circuit 22 and the scan line drive circuit 23 (drive circuit) to generate a superimposed signal and output the superimposed signal to the backlight device (backlight module). The liquid crystal display device 1 of the present embodiment also includes, on the active matrix substrate 5, a photosensor unit (light-electricity transducer) 18 that receives light from the light-emitting diode 8 and outputs an electrical signal corresponding to the received light, and a decoding circuit (decoding module) 19 that decodes the electrical signal from the photosensor unit 18 into the drive signal and outputs it to the data line drive circuit 22 and the scan line drive circuit 23 via a timing generating circuit 20 and a VRAM 21. In this way, the liquid crystal display device 1 of the present embodiment uses light to input a signal from the panel control module 15 into the active matrix substrate 5, such that, contrary to the conventional implementation discussed above, the number of electrical lines connected to the active matrix substrate 5 can be reduced even when the number of pixels in the liquid crystal panel (display module) 2 is increased. As a result, according to the present embodiment, a liquid crystal display device 1 with a simple arrangement can be made.

Further, drive signals, discussed above, of the present embodiment include a clock signal and a data signal corresponding to a video signal from the outside. Thus, the liquid crystal display device 1 of the present embodiment is capable of turing on the light-emitting diode 8 in timing suitable for the video signal and of driving pixels P suitably for the video signal.

### Second Embodiment

FIG. 6 illustrates the configuration of main portions of a liquid crystal display device according to a second embodiment of the present invention. In the drawing, the present embodiment is different from the first embodiment mainly in that a solar cell unit, instead of a photosensor unit, is provided on the active matrix substrate. Note that the components common to the first and second embodiments are labeled with the same numerals, and the overlapping description is omitted.

Specifically, as shown in FIG. 6, in a liquid crystal display device 1 of the present embodiment, a solar cell unit 27 as a light-electricity transducer is mounted on the active matrix substrate 5 outside the effective pixel region A. The solar cell unit 27 is provided on the active matrix substrate 5 in such a way that its light receiving side is opposite the light guide plate 9 (FIG. 1). In other words, the solar cell unit 27 is configured to detect only light from the light-emitting diode 8, and not to receive light from outside the liquid crystal display device 1 (external light).

Further, similar to the photosensor unit 18 of the first embodiment, after receiving light from the light-emitting diode 8, the solar cell unit 27 is configured to output a detection signal corresponding to the received light in the form of an electrical signal to the decoding circuit 19. Furthermore, as indicated by the thick arrow lines in FIG. 6, the solar cell unit 27 is connected with the decoding circuit 19, the data line drive circuit 22 and the scan line drive circuit 23 via power supply lines. Thus, the solar cell unit 27 supplies electrical power obtained from received light to the decoding circuit 19, the data line drive circuit 22 and the scan line drive circuit 23.

In this way, the present embodiment achieves the same effects and advantages as the first embodiment. Moreover, in the present embodiment, the solar cell unit 27 obtains electrical power from received light, in addition to the electrical signal, and supplies the electrical power to the decoding circuit 19, the data line drive circuit 22 and the scan line drive circuit 23. Thus, in the present embodiment, the solar cell unit 27 provides electrical power required for the solar cell unit 27 itself, the decoding circuit 19, the data line drive circuit 22 and the scan line drive circuit 23. As a result, contrary to the first embodiment, the present embodiment easily reduces power consumption of the liquid crystal display device 1. In addition, electrical lines for supplying electrical power to the active matrix substrate 5 can be omitted such that a display device 1 with a simple structure can be designed in an easy way.

It should be noted that all of the above embodiments are exemplary only and not limitative. The technical scope of the present invention is defined by the Claims, and all the modifications thereof equivalent to the arrangements cited in the Claims are within the technical scope of the present invention.

For example, the above description illustrated a transparent liquid crystal display device. However, the display device of the present invention is not limited thereto, and may be applied to various non-emissive display devices for displaying information using light from a light source. Particularly, the display device of the present invention may be suitably used for semi-transparent liquid crystal display devices or projection display devices such as rear-projection devices using the liquid crystal panel described above as a light bulb.

In the above description, a photosensor unit or a solar cell unit is used as a light-electricity transducer. However, the light⁻electricity transducer of the present invention is not limited thereto and may be any device that is provided on the active matrix substrate and that receives light from a light source and outputs an electrical signal corresponding to the received light.

In the above description, a photosensor unit or a solar cell unit which is a light-electricity transducer is provided outside the effective pixel region of the active matrix substrate. However, the present invention is not limited thereto, and a light-electricity transducer may be provided inside the effective pixel region, for example.

In the above description, a panel control module (display control module) and a backlight control module are unified as a control module. However, the present invention is not limited thereto, and a display control module may be separate from a backlight control module.

In the above description, the decoding circuit (decoding module) is separate from the timing generating circuit and the VRAM. However, the present invention is not limited thereto, and a timing generating circuit and a VRAM may be provided inside the decoding module and integrated into the decoding module, for example.

In the above description, a light-emitting diode is used as a light source. However, the light source of the present invention is not limited thereto, and other point light sources such as a lamp or a discharge tube such as a cold cathode fluorescent tube or other light-emitting devices such as an organic EL (electronic luminescence) may be used as a light source.

However, using a light-emitting diode as a light source as in the above embodiments is more preferable, since it facilitates making a smaller backlight module and designing a compact display device.

In the above description, current dimming is used to turn on the light-emitting diode (light source). However, the present invention is not limited thereto, and PWM dimming, for example, may be used to turn on the light source.

In the above description, the brightness of light from the light-emitting diode is changed to transmit a superimposed signal in which a drive signal for the liquid crystal panel 2 is superimposed on a lighting signal. However, a superimposed signal may be transmitted by changing the light emission cycle of the light-emitting diode or the ON width, OFF width or the like of signals input into the light-emitting diode.

Finally, in the above description, the photosensor unit 18 is provided outside the effective pixel region A of the display side of the liquid crystal panel 2 on the active matrix substrate 5. However, photosensors may be provided in pixels contained in the display side.

### INDUSTRIAL APPLICABILITY

The present invention is useful in a display device with a simple structure where the number of electrical lines connected to the active matrix substrate can be reduced even when the number of pixels in the display module is increased.

1. A display device comprising:
a backlight module having a light source;
a display module having an active matrix substrate with a plurality of pixels for displaying information using illumination light generated by the backlight module;
a backlight control module that outputs a lighting signal for drive-controlling the backlight module; and
a display control module that outputs a drive signal for drive-controlling the display module,
wherein on the active matrix substrate are provided:
a drive circuit that drives the plurality of pixels on a pixel-by-pixel basis;
a superimposing module that superimposes the drive signal output from the display control module on the lighting signal output from the backlight control module to generate a superimposed signal and output the superimposed signal to the backlight module;
a light-electricity transducer that receives light from the light source and outputs an electrical signal corresponding to the received light; and
a decoding module that decodes the electrical signal from the light-electricity transducer to the drive signal and outputs it to the drive circuit.

2. The display device according to claim 1, wherein the light-electricity transducer is a photosensor unit.

3. The display device according to claim 1, wherein the light-electricity transducer is a solar cell unit, and
the solar cell unit is configured to obtain electrical power from the received light, in addition to the electrical signal, and supply the electrical power to the drive circuit and the decoding module.

4. The display device according to claim 1, wherein the drive signal contains a clock signal and a data signal corresponding to a video signal from an outside.

5. The display device according to claim 1, wherein the display module includes a liquid crystal panel, and
on the active matrix substrate are provided a plurality of data lines and a plurality of scan lines arranged in a matrix and switching devices near intersections between the data lines and the scan lines, and
the drive circuit contains a data line drive circuit connected to the data lines and a scan line drive circuit connected to the scan lines.
